(19) United States
(12) Patent Application Publication
(10) Pub. No.: US 2024/0367247 A1
(43) Pub. Date: Nov. 7, 2024

(54) METHOD FOR MANUFACTURING TIP FOR METAL CUTTING CIRCULAR SAW AND METHOD FOR MANUFACTURING METAL CUTTING CIRCULAR SAW USING THE SAME

(71) Applicant: TANITEC Corporation, Tsuzuki-gun, Kyoto (JP)

(72) Inventors: Hiromitsu Ishikura, Tsuzuki-gun (JP); Kohei Tani, Tsuzuki-gun (JP)

(73) Assignee: TANITEC Corporation, Tsuzuki-gun, Kyoto (JP)

(21) Appl. No.: 18/561,382

(22) PCT Filed: Apr. 25, 2022
(86) PCT No.: PCT/JP2022/018687

§ 371 Date: Nov. 16, 2023

(51) Int. Cl. B23D 65/02

(52) U.S. Cl. CPC B23D 65/02

(57) ABSTRACT

The method for manufacturing a substantially rectangular parallelepiped tip 1 includes using an upper punch 25 for pressing a sand-like tip-forming metal material SM from above, a lower punch 26 for pressing the tip-forming metal material SM from below, and a mortar die 21 into which the tip-forming metal material SM is injected, making a lower surface 25a of the upper punch 25 into a forming surface of a rake face 2 side portion of the tip 1, making an upper surface 26a of the lower punch 26 into a forming surface of an opposite side surface 11 portion of the rake face 2 of the tip 1, and making one side inner surface 24a of the cavity 24 of the mortar die 21 into a forming surface of a flank 5 portion of the tip 1.

### TECHNICAL FIELD

The present invention relates to a method for manufacturing a tip for a metal cutting circular saw and a method for manufacturing a metal cutting circular saw using the same.

### BACKGROUND ART

A metal cutting circular saw has a disk-shaped base metal constituting a main body thereof and substantially rectangular parallelepiped tips that are fixed by brazing or the like to pedestals of saw blade portions protrudingly provided on an outer periphery of the base metal at fixed intervals.

Further, a specific metal cutting circular saw is known, for which the saw blade portions are formed on the outer periphery of the disk-shaped base metal at predetermined intervals and a cutting edge tip is fixed to each saw blade portion, and in which a stepped portion is formed on a side flank of the cutting edge tip, and a tapered chamfered portion is formed on the cutting edge tip and the saw blade portion. Further, a chip dividing groove is formed on the flank according to need.

A method for manufacturing the metal cutting circular saw having the foregoing configuration is generally such that a rectangular parallelepiped tip material is first fixed to the saw blade portion of the base metal by brazing or the like, and then, the tip material is ground with a grinding stone to perform sharpening of a predetermined rake face and rake angle and a predetermined flank and clearance angle, thereby forming the cutting edge tip.

### CITATION LIST

### Patent Literatures

Patent Literature 1: Japanese Unexamined Patent Application Publication No. 2012-056067
Patent Literature 2: Japanese Unexamined Patent Application Publication No. 2009-214250

### SUMMARY OF INVENTION

### Technical Problem

The cutting edge tip usually has various fine designs applied to the foregoing rake face, flank, and the like in order to obtain a desired level of cutting performance, reduce the cutting resistance, and the like, and accordingly, the shape of the cutting edge tip has become more complicated in actuality. Therefore, the grinding process needs to be performed many times when the grinding stone is brought into contact with the foregoing rectangular parallelepiped tip material to perform form grinding, so that there has been a problem of requiring a large amount of labor and cost to obtain the cutting edge tip shape of the final design structure.

Accordingly, an object of the present invention is to provide a method for manufacturing a tip for a metal cutting circular saw, which omits the foregoing process of grinding the tip many times and enables manufacturing a cutting edge tip simply and at a low cost and a method for manufacturing a metal cutting circular saw using the same.

### Solution to Problem

The present invention according to Claim 1 is a method for manufacturing a tip for a metal cutting circular saw in which a substantially rectangular parallelepiped tip is manufactured using an upper punch for pressing a sand-like tip-forming metal material from above, a lower punch for pressing the tip-forming metal material from below, and a mortar die having a cavity into which the tip-forming metal material is injected, the method characterized by including making a lower surface of the upper punch into a forming surface of a rake face side portion of the tip, making an upper surface of the lower punch into a forming surface of an opposite side portion of the rake face of the tip, making one side inner surface of the cavity of the mortar die into a forming surface of a flank portion of the tip, making the other side inner surface of the cavity of the mortar die into a forming surface of an opposite side portion of the flank of the tip, injecting the tip-forming metal material into a forming space formed by entering the lower punch into the cavity of the mortar die, then, lowering the upper punch, forming the tip-forming metal material into a substantially oblong rectangular parallelepiped tip shape having a predetermined clearance angle and a predetermined rake angle by the upper punch, the lower punch, and the mortar die, and sintering the tip formed product.

The present invention according to Claim 2 is characterized in that the lower surface of the upper punch and the upper surface of the lower punch are formed into inclined surfaces corresponding to a clearance angle of the tip to be formed, thereby forming the tip-forming metal material into a tip shape having the predetermined clearance angle in the method for manufacturing the tip for the metal cutting circular saw according to Claim 1 described above.

The present invention according to Claim 3 is characterized in that the inclined surface of the lower surface of the upper punch has an upper portion provided with a reverse inclined cutting edge forming surface portion corresponding to a cutting edge of the rake face of the tip to be formed, thereby forming the tip-forming metal material into a tip shape provided with the cutting edge having the predetermined rake angle in the method for manufacturing the tip for the metal cutting circular saw according to Claim 2.

The present invention according to Claim 4 is characterized in that the inclined surface of the upper surface of the lower punch has a lower portion provided with a protrusion having a substantially inverted V-shaped cross section in the method for manufacturing the tip for the metal cutting circular saw according to Claim 2 or Claim 3 described above.

The present invention according to Claim 5 is characterized in that the lower surface of the upper punch and the upper surface of the lower punch are formed into horizontal planes, and the horizontal plane of the lower surface of the upper punch has one side portion provided with a cutting edge forming surface portion of a predetermined inclination shape corresponding to a cutting edge of the rake face of the tip to be formed, and the cavity of the mortar die has one side inner surface provided with a flank-forming inclined surface portion inclined inward of the cavity from a lower end of the cutting edge forming surface portion of the upper punch toward the lower punch side, thereby forming the tip-forming metal material into a tip shape having a predetermined clearance angle and a predetermined rake angle in the method for manufacturing the tip for the metal cutting circular saw according to Claim 1 described above.

The present invention according to Claim 6 is characterized in that the upper surface of the lower punch has the other side portion provided with a protrusion having a substantially inverted V-shaped cross section in the method for manufacturing the tip for the metal cutting circular saw according to Claim 5 described above.

The present invention according to Claim 7 is characterized in that a plurality of the cavities are provided to the mortar die, and corresponding to the plurality of cavities, a plurality of the upper punches are provided to the upper die, and a plurality of the lower punches are provided to the lower die, and a plurality of the tip formed products are formed by a single operation of forming, and the tip formed products are put into a sintering furnace to simultaneously sinter a plurality of the tips in the method for manufacturing the tip for the metal cutting circular saw according to any one of Claim 1 to Claim 6 described above.

The present invention according to Claim 8 is a method for manufacturing a metal cutting circular saw characterized by fixing the tip obtained by the tip manufacturing method according to any one of Claim 1 to Claim 7 described above to each pedestal formed on an outer periphery of a base metal at a predetermined interval.

The present invention according to Claim 9 is characterized in that the tip is deburred before being fixed to each pedestal of the base metal in the method for manufacturing the metal cutting circular saw according to Claim 8 described above.

The present invention according to Claim 10 is characterized in that a coating is applied to a surface of the tip before the deburred tip is fixed to each pedestal of the base metal in the method for manufacturing the metal cutting circular saw according to Claim 9 described above.

### Advantageous Effects of Invention

According to the method for manufacturing the tip for the metal cutting circular saw of the present invention, a special effect is obtained in that the tip can be manufactured simply and inexpensively by simplified uniaxial forming with the upper punch of the upper die, the lower punch of the lower die, and the mortar die. In the tip manufacturing method of the present invention, in short, the forming surface portions for forming the flank having a predetermined clearance angle and the rake face having a predetermined rake angle are provided to the upper punch, the lower punch, and the mortar die, so that the tip formed product provided with the flank having a predetermined clearance angle and the rake face having a predetermined rake angle is obtained only by shaping the tip-forming metal material with these dies, and the tip formed product is sintered, whereby a final sharpened tip is obtained. Accordingly, a special effect is obtained in that the conventional complicated grinding work can be omitted. Further, according to the tip manufacturing method of the present invention in which a plurality of cavities are provided to the mortar die, and corresponding to the plurality of cavities, a plurality of upper punches are provided to the upper die, and a plurality of lower punches are provided to the lower die, and a plurality of tip formed products are formed by a single operation of forming, and the tip formed products are put into a sintering furnace to simultaneously sinter a plurality of tips, tips each sharpened into a predetermined shape can be obtained at a time, so that it becomes possible to significantly reduce the tip manufacturing cost.

### BRIEF DESCRIPTION OF DRAWINGS

FIG. 1 is a perspective view of a tip manufactured by a tip manufacturing method according to an embodiment of the present invention.

FIG. 2 is an enlarged side view of an outer edge portion of a metal cutting circular saw to which the tip of FIG. 1 is fixed.

FIG. 3 is an enlarged side view of a saw blade portion of the metal cutting circular saw of FIG. 2.

FIG. 4 is an enlarged front view of the saw blade portion of the metal cutting circular saw of FIG. 3 viewed from a direction of a rake face of the tip thereof.

FIG. 5 is an enlarged plan view of the saw blade portion of the metal cutting circular saw of FIG. 3 viewed from a direction of a flank of the tip thereof.

FIG. 6 is an enlarged front view showing another embodiment of the tip with respect to FIG. 4.

FIG. 7 is an enlarged front view showing yet another embodiment of the tip with respect to FIG. 4.

FIG. 8 are perspective views of a forming die used for the tip manufacturing method according to the embodiment of the present invention, wherein FIG. 8(a) shows an upper die, FIG. 8(b) a mortar die, and FIG. 8(c) a lower die.

FIG. 9 is a front side sectional view of the mortar die.

FIG. 10 are schematic diagrams showing steps of the tip manufacturing method according to the embodiment of the present invention, wherein FIG. 10(a) shows a state in which a tip-forming metal material is filled into a cavity formed by the mortar die and a lower punch, FIG. 10(b) shows a state of completion of the filling of the tip-forming metal material, FIG. 10(c) shows a state of tip forming by upper and lower punches within the mortar die, and FIG. 10(d) shows a state after the tip forming.

FIG. 11 is an enlarged sectional view showing the state of tip forming within the dies.

FIG. 12 is an enlarged sectional view showing another embodiment of the present invention with respect to FIG. 11.

FIG. 13 is an enlarged view of a main part of FIG. 12.

FIG. 14 is an enlarged side view of the saw blade portion of the metal cutting circular saw showing a state in which a tip is fixed to a pedestal according to another embodiment.

### DESCRIPTION OF EMBODIMENTS

Next, embodiments of the present invention will be described according to the drawings. However, the present invention should not be limited to the embodiments.

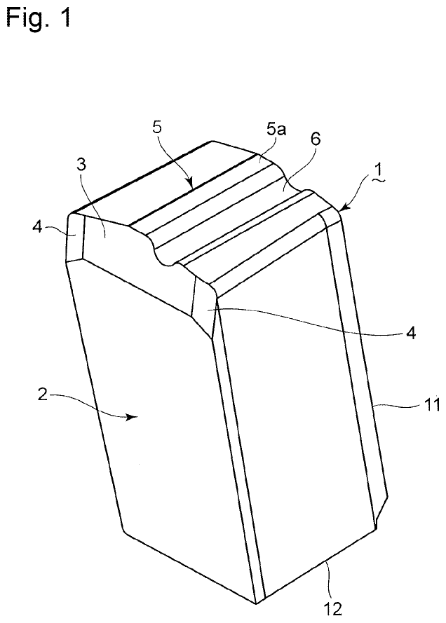

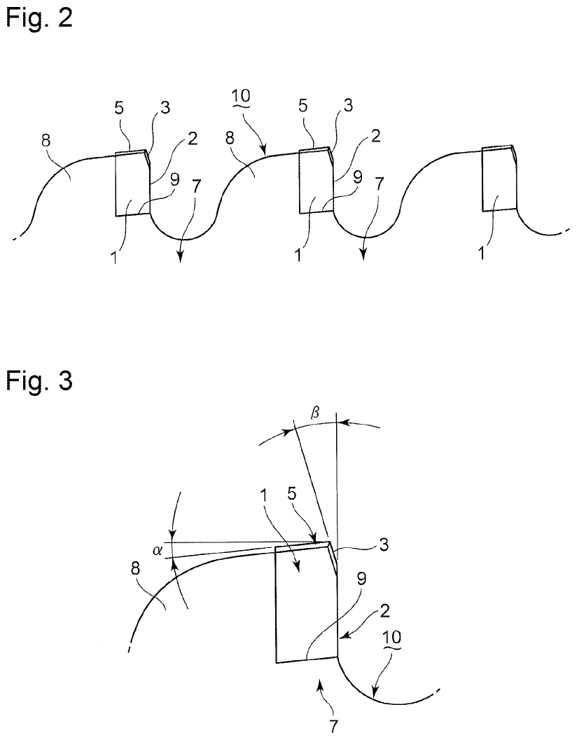

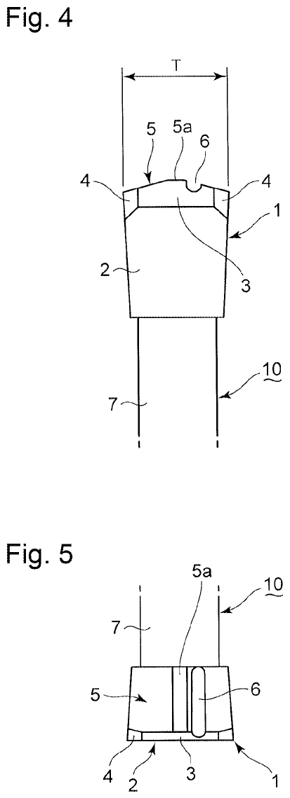

As shown in FIG. 1 to FIG. 5, the shape of a tip formed by a method for manufacturing a tip for a metal cutting circular saw according to the present embodiment will be described. A tip 1 has a substantially rectangular parallelepiped shape as a whole, has a front surface made into a rake face 2, has a distal end portion of the rake face 2 formed with a cutting edge 3, and has a chamfer 4 on both sides of the cutting edge 3. The tip 1 has a distal end portion formed with a flank 5, and the flank 5 has a mountain shape when viewed from the front and has a central portion in a tip thickness T direction formed with a plane portion 5a. The plane portion 5a of the flank 5 has one side formed with a chip dividing groove 6.

The tip 1 of the foregoing shape is fixed by brazing or the like to an L-shaped pedestal 9 at a saw blade portion 8 protrudingly provided at a predetermined interval to a base metal 7 of a metal cutting circular saw 10, and further, the tip 1 has a predetermined clearance angle α and a predetermined rake angle β.

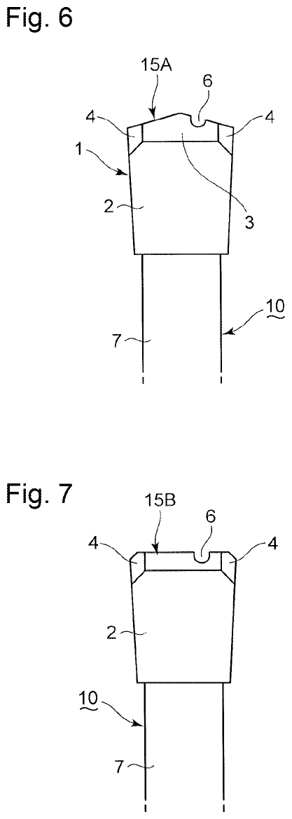

As shown in FIG. 6 and FIG. 7, the shape of the tip 1 is not limited to the above one and may be one having a flank 15A (FIG. 6) of a sharp mountain shape when viewed from the front in which the central portion in the tip thickness T direction is pointed or be one having a flat flank 15B (FIG. 7) as a whole. Since other portions of the tip 1 are the same as those of the tip structure described above, they are denoted by the same reference signs and descriptions thereof are omitted.

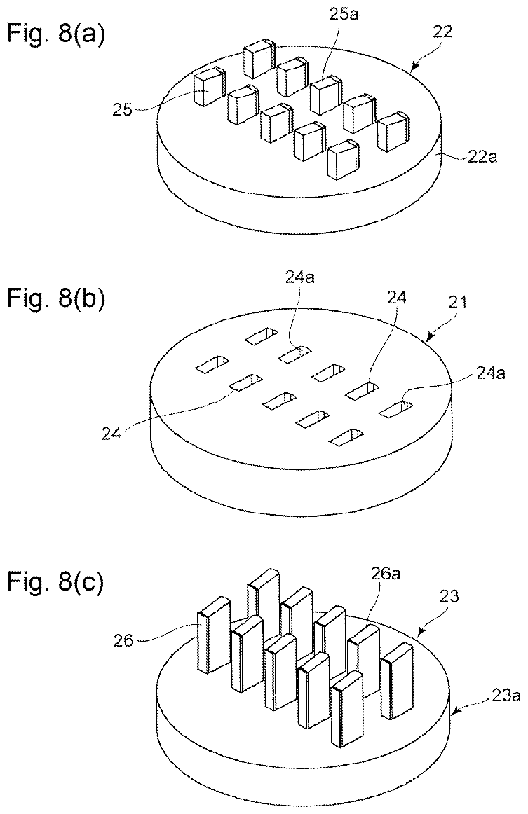

Next, a forming die of the tip 1 will be described. As shown in FIGS. 8(a) to 8(c), the forming die is composed of a central mortar die 21 (FIG. 8(b)), an upper die 22 (FIG. 8 (a)) arranged above the mortar die 21, and a lower die 23 (FIG. 8(c)) arranged below the mortar die 21.

More specifically, the mortar die 21 described above has a substantially disk-like shape as a whole and has a central portion arranged with a total of 10 tip-forming cavities 24 in two rows. The tip-forming cavity 24 has a penetration shape with a substantially rectangular cross section corresponding to the foregoing shape of the substantially rectangular parallelepiped tip 1 to be formed. The tip-forming cavity 24 has one side inner surface 24a made into a forming surface of the flank 5 of the tip 1.

The upper die 22 has a substantially disk-shaped upper die main body 22a and a total of 10 upper punches 25 protruding from the upper die main body 22a and entering corresponding tip-forming cavities 24 of the mortar die 21 from above.

The lower die 23 has a substantially disk-shaped lower die main body 23a and a total of 10 lower punches 26 protruding from the lower die main body 23a and entering corresponding tip-forming cavities 24 of the mortar die 21 from below.

These dies 21 to 23 are, with normal structures, incorporated into an existing die device. Specifically, in the die device, the upper die 22 is arranged above the mortar die 21 so that the upper punches 25 face downward, and the lower die 23 is arranged below the mortar die 21 so that the lower punches 26 face upward. The upper die 22 and the lower die 23 are incorporated so as to be approachable to the mortar die 21, and each upper punch 25 of the upper die 22 and each lower punch 26 of the lower die 23 enter a corresponding tip-forming cavity 24 of the mortar die 21, whereby a formed product of the tip 1 is formed from a predetermined sand-like metal forming material in the tip-forming cavity 24 by each upper punch 25 and each lower punch 26.

That is, the tip manufacturing method according to the present invention is such that the tip 1 is sintered and formed by uniaxial forming in which the upper punch 25 enters the tip-forming cavity 24 of the mortar die 21 from an upper direction and the lower punch 26 from a lower direction.

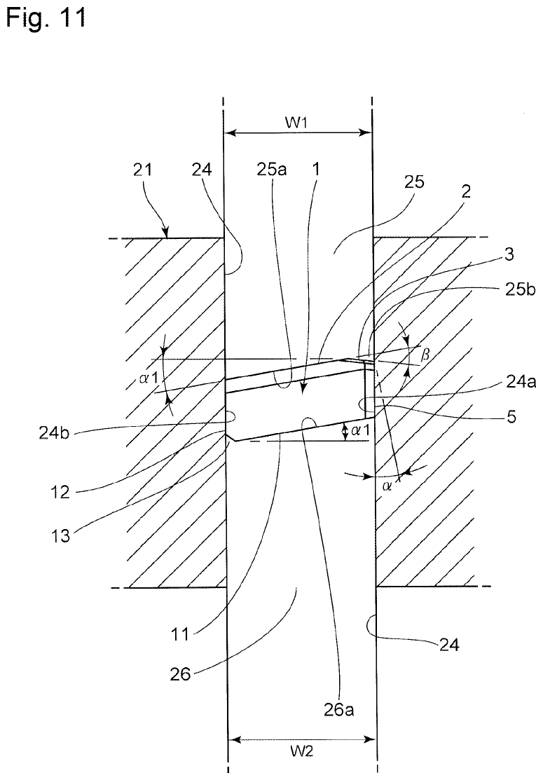

As will be described later, a distal end surface (lower surface in the die device) 25a of each upper punch 25 of the upper die 22 is made into a forming surface of the rake face 2 side of the tip 1, and a distal end surface 26a (upper surface in the die device) of the lower punch 26 of the lower die 23 is made into a forming surface of an opposite side portion 11 of the rake face of the tip 1. Further, the distal end surface (lower surface in the die device) 25a of each upper punch 25 of the upper die 22 has one end side portion provided with a forming surface 25b of the cutting edge 3 (see FIG. 11).

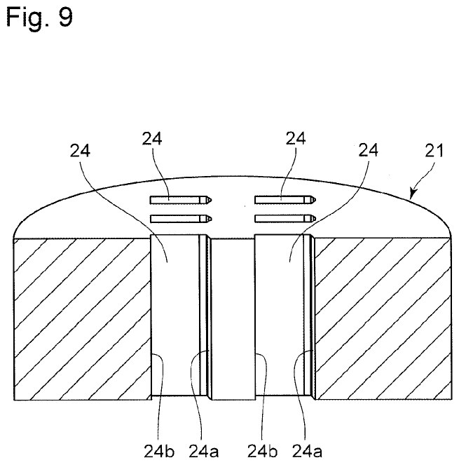

Next, as shown in FIG. 9, each tip-forming cavity 24 of the mortar die 21 is formed in an elongated hole shape having a substantially square cross section penetrating vertically, and as described above, the upper punch 25 of the upper die 22 enters from above and the lower punch 26 of the lower die 23 from below each tip-forming cavity 24 of the mortar die 21, whereby a forming space of the tip 1 is formed in each tip-forming cavity 24 of the mortar die 21.

As described above, the one side inner surface 24a of each tip-forming cavity 24 is made into the forming surface of the flank 5 portion of the tip 1, and the other side inner surface 24b of each tip-forming cavity 24 is made into a forming surface of an opposite side portion 12 of the flank 5 of the tip 1.

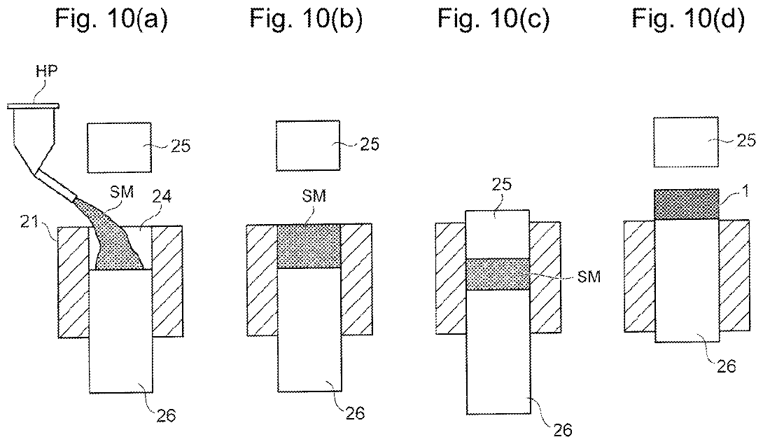

Next, as shown in FIGS. 10, the procedure for forming and manufacturing the tip 1 by the mortar die 21, the upper die 22, and the lower die 23 using a sand-like tip-forming metal material SM to be a forming material of the tip 1 will be described. The tip-forming metal material SM is first injected from a hopper HP to the forming space in the cavity 24 formed by entering the lower punch 26 of the lower die 23 into each tip-forming cavity 24 of the mortar die 21 from below (see FIG. 10(a) and FIG. 10(b)), and then, the lower die 23 is only slightly lowered so that each lower punch 26 thereof is lowered, each upper punch 25 of the upper die 22 is lowered from above into the forming space in the cavity 24 (see FIG. 10 (c)), whereby the tip-forming metal material SM is formed, within the dies, into a tip formed product corresponding to the substantially rectangular parallelepiped tip 1 having a predetermined clearance angle α and a predetermined rake angle β. The tip formed product is then removed from the dies (see FIG. 10(d)) and is put into a sintering furnace to be baked (sintered), and a desired sharpened tip 1 is finally obtained.

More specifically, as shown in FIG. 11, the method for manufacturing the tip for the metal cutting circular saw 10 according to the present invention is the method for manufacturing the substantially rectangular parallelepiped tip 1 using the upper punch 25 of the upper die 22 for pressing the sand-like tip-forming metal material SM from above, the lower punch 26 of the lower die 23 for pressing the tip-forming metal material SM from below, and the mortar die 21 having the cavity into which the tip-forming metal material SM is injected, as described above, and the method includes making the lower surface 25a of the upper punch 25 into the forming surface of the rake face 2 side portion of the tip 1, making the upper surface 26a of the lower punch 26 into the forming surface of the opposite side surface 11 portion of the rake face 2 of the tip 1, making the one side inner surface 24a of the cavity 24 of the mortar die 21 into the forming surface of the flank 5 portion of the tip 1, making the other side inner surface 24b of the cavity 24 of the mortar die 21 into the forming surface of the opposite side portion 12 of the flank 5 of the tip 1, injecting the tip-forming metal material SM into the forming space in the cavity 24 formed by entering the lower punch 26 into the cavity 24 of the mortar die 21, and then, lowering the upper punch 25, and forming the tip-forming metal material SM into the tip formed product corresponding to the substantially oblong rectangular parallelepiped tip 1 shape having the predetermined clearance angle α and the predetermined rake angle β by the lower surface 25a of the upper punch 25, the upper surface 26a of the lower punch 26, and the both side inner surfaces 24a, 24b of the mortar die 21. The tip formed product having the tip 1 shape is then taken out of the dies 21, 22, 23 described above and is put into a sintering furnace (not shown) to be sintered, thereby finally obtaining the sharpened tip 1 having the predetermined clearance angle α and the predetermined rake angle β. In the actual forming of the tip 1, as shown in FIGS. 8(a) to 8(c), a plurality (10 in the present embodiment) of cavities 24, upper punches 25, and lower punches 26 corresponding to each other form a plurality of tip formed products having the tip 1 shape by a single operation of forming, and the tip formed products are put into a sintering furnace (not shown) to be sintered, thereby finally manufacturing a plurality of tips 1 at a time by the single operation of forming.

In the present embodiment, as shown in FIG. 11, the lower surface 25a of the upper punch 25 and the upper surface 26a of the lower punch 26 are formed into inclined surfaces (inclination angle α1) corresponding to the clearance angle α of the tip 1 to be formed, thereby forming the tip-forming metal material SM into a tip 1 shape having the predetermined clearance angle α. Furthermore, in the present embodiment, the inclined surface of the lower surface 25a of the upper punch 25 has an upper portion provided with a reverse inclined cutting edge forming surface portion 25b corresponding to the cutting edge 3 of the rake face 2 of the tip 1 to be formed, thereby forming the tip-forming metal material SM into a tip shape provided with the cutting edge 3 having the predetermined rake angle β. In the present embodiment, the inclination angle α1 of the lower surface 25a of the upper punch 25 and the upper surface 26a of the lower punch 26 and the clearance angle α of the flank 5 of the tip 1 are identical to each other. However, both angles may sometimes be different. In short, the gist of the present embodiment is to appropriately set the inclination angle α1 of the lower surface 25a of the upper punch 25 and the inclination angle α1 of the upper surface 26a of the lower punch 26 in order that the flank 5 of the tip 1 has the predetermined clearance angle α.

In the present embodiment, the cutting edge forming surface portion 25b has a surface inclined reverse to the inclined surface of the lower surface 25a of the upper punch 25, as described above.

In the present embodiment, as described above, a total of 10 cavities 24 are provided to the mortar die 21, and corresponding to the cavities 24, 10 upper punches 25 of the upper die 22 and 10 lower punches 26 of the lower die 23 are also provided to obtain 10 tip-formed products by a single operation of forming.

As shown in FIG. 11, in the present embodiment, the inclined surface of the upper surface 26a of the lower punch 26 has a lower portion provided with a protrusion 13 having a substantially inverted V-shaped cross section. The protrusion 13 has the function of facilitating removing the formed tip 1 from the dies and preventing the occurrence of burrs.

The tip 1 manufactured by the tip manufacturing method described above may have burrs on the front and rear sides, etc., of the flank 5 thereof, and in this case, the tip 1 is subjected to a grinding process such as spraying an abrasive or the like on the tip 1 or bringing a brush into contact with the tip 1 to perform deburring.

The deburred tip described above is sometimes subjected to coating treatment such as a physical vapor deposition (PVD) coating or a chemical vapor deposition (CVD) coating.

Since the tip 1 as a finally obtained finished product has been sharpened as described above, it does not need to be sharpened by performing the conventional grinding work, and the metal cutting circular saw 10 is manufactured by fixing the tip 1 by brazing or the like to the pedestal 9 of each saw blade portion 8 in the base metal 7 of the metal cutting circular saw 10 as it is.

Next, another embodiment of the tip manufacturing method according to the present invention will be described. In the present embodiment, the use of the foregoing mortar die 21, the upper die 22, and the lower die 23 is the same as in the foregoing embodiment, but the configurations of the cavity 24 of the mortar die 21, the upper punch 25 of the upper die 22, and the lower punch 26 of the lower die 23 are changed.

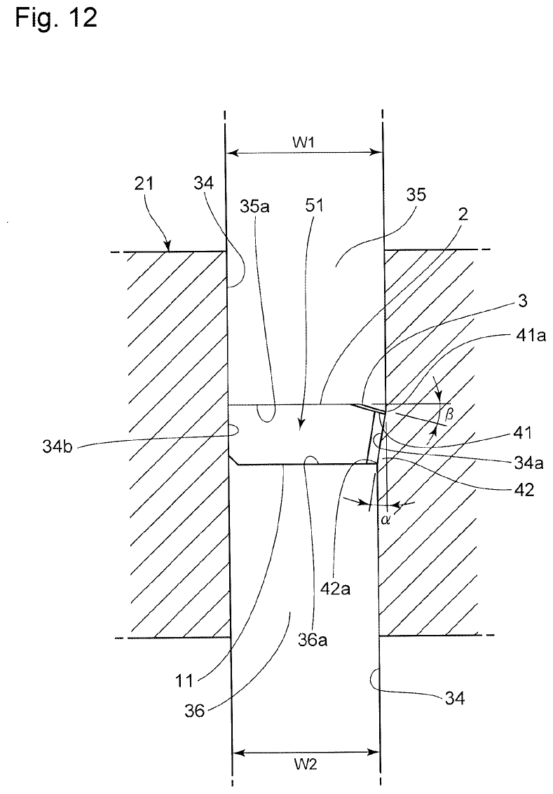

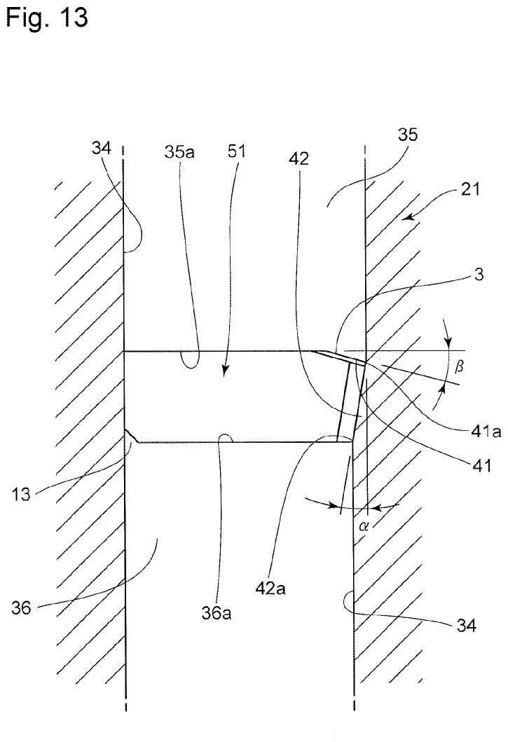

Specifically, as shown in FIG. 12 and FIG. 13, the method for manufacturing a tip according to the present embodiment will be described. The manufacturing method is a method for manufacturing a tip 51 having the same substantially rectangular parallelepiped shape in the foregoing by using an upper punch 35 of the upper die 22 for pressing a sand-like tip-forming metal material SM from above, a lower punch 36 of the lower die 23 for pressing the tip-forming metal material SM from below, and a cavity 34 of the mortar die 21 into which the tip-forming metal material SM is injected, and the method includes making a lower surface 35a of the upper punch 35 into a forming surface of a rake face 2 side portion of the tip 51, making an upper surface 36a of the lower punch 36 into a forming surface of an opposite side surface 11 portion of the rake face 2 of the tip 1, making one side inner surface 34a of the cavity 34 of the mortar die 21 into a forming surface of a flank 5 portion of the tip 51, making the other side inner surface 34b of the cavity 34 of the mortar die 21 into a forming surface of an opposite side surface 12 portion of the flank 5 of the tip 51, injecting the tip-forming metal material SM into a forming space formed by entering the lower punch 36 into the cavity 34 of the mortar 21, then, lowering the upper punch 35, forming the tip-forming metal material SM into a tip formed product having a substantially oblong rectangular parallelepiped tip shape having a predetermined clearance angle α and a predetermined rake angle β by the lower surface 35a of the upper punch 35, the upper surface 36a of the lower punch 36, and the both side inner surfaces 34a, 34b of the mortar die 21, removing the tip formed product from the dies 21, 22, 23 described above, and putting the tip formed product into a sintering furnace (not shown) to be sintered, thereby finally obtaining the tip 51 having the predetermined shape described above.

In the present embodiment, the lower surface 35a of the upper punch 35 and the upper surface 36a of the lower punch 36 are formed into horizontal planes, and the horizontal plane of the lower surface 35a of the upper punch has one side portion provided with a cutting edge forming surface portion 41 of a predetermined inclination shape corresponding to a cutting edge 3 of the rake face 2 of the tip 1 to be formed, and the cavity 34 of the mortar die 22 has one side inner surface 34a provided with a flank-forming inclined surface portion 42 inclined inward of the cavity 34 from a lower end 41a of the cutting edge forming surface portion 41 of the upper punch 35 toward the lower punch 36 side, thereby forming a tip formed product provided with the flank 5 having a predetermined clearance angle α and the cutting edge 3 having a predetermined rake angle β.

More specifically, the cutting edge forming surface portion 41 is inclined downward toward the one side inner surface 34a side of the cavity 34 of the mortar die 21. Further, the upper surface 36a of the lower punch 36 has the other side portion provided with a protrusion 13 having a substantially inverted V-shaped cross section in the same manner as in the foregoing embodiment.

The tip formed product obtained by the forming method described above is put into a sintering furnace (not shown) to be sintered in the same manner as in the foregoing embodiment, and the tip 1 having been already sharpened is finally manufactured.

As shown in FIG. 11, in the foregoing embodiment, the width W1 of the upper punch 25 and the width W2 of the lower punch 26 are identical to each other, but in the present embodiment, a structure is provided such that the width W of the lower punch 26 is narrower than the width W1 of the upper punch 25 by the protruding amount of the flank-forming inclined surface portion 42.

A configuration is provided such that the upper surface 36a of the lower punch 36 is located at a lower end portion 42a of the flank-forming inclined surface portion 42 in the cavity 34 of the mortar die 22 and that the upper punch 35 has its cutting edge forming surface portion 41 located at an upper end portion 42b of the flank-forming inclined surface portion 42 of the mortar die 21.

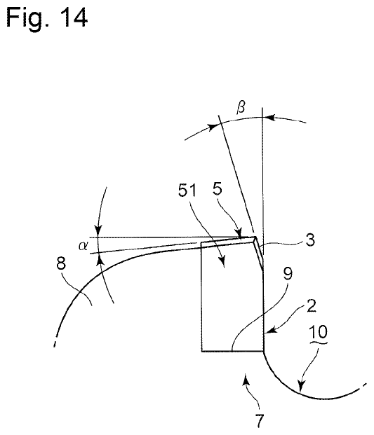

According to the configurations of the dies described above, the cutting edge forming surface portion 41 of the upper punch 25 forms the cutting edge 3 of the tip 1 to be formed, and the flank-forming inclined surface portion 42 of the mortar die 21 forms the flank 5 of the tip 1 to be formed. The inclination angle of the flank-forming inclined surface portion 42 corresponds to the clearance angle α, and the inclination angle of the cutting edge forming surface portion 41 corresponds to the rake angle β. As shown in FIG. 14, the tip 51 manufactured by the tip manufacturing method of the present embodiment is fixed by brazing or the like to the pedestal 9 in the saw blade portion 8 of the metal cutting circular saw 10, in the same manner as the tip 1 in the foregoing embodiment.

### INDUSTRIAL APPLICABILITY

According to the method for manufacturing the tip for the metal cutting circular saw according to the present invention, the tip can be manufactured simply and inexpensively by simplified uniaxial forming with the upper punch of the upper die, the lower punch of the lower die, and the mortar die, so that a wide range of uses can be expected in the field of manufacturing of tips for metal cutting circular saws.

### REFERENCE SIGNS LIST

1 Tip
2 Rake face
3 Cutting edge
5 Flank
10 Metal cutting circular saw
21 Mortar die
22 Upper die
23 Lower die
24, 34 Tip-forming cavity
25, 35 Upper punch
25a, 35a Lower surface of upper punch
26, 36 Lower punch
26a, 36a Upper surface of lower punch 26

1. A method for manufacturing a tip for a metal cutting circular saw in which a substantially rectangular parallelepiped tip is manufactured using an upper punch for pressing a sand-like tip-forming metal material from above, a lower punch for pressing the tip-forming metal material from below, and a mortar die having a cavity into which the tip-forming metal material is injected, the method comprising: making a lower surface of the upper punch into a forming surface of a rake face side portion of the tip; making an upper surface of the lower punch into a forming surface of an opposite side portion of the rake face of the tip; making one side inner surface of the cavity of the mortar die into a forming surface of a flank portion of the tip; making the other side inner surface of the cavity of the mortar die into a forming surface of an opposite side portion of the flank of the tip; injecting the tip-forming metal material into a forming space formed by entering the lower punch into the cavity of the mortar die; then, lowering the upper punch; forming the tip-forming metal material into a substantially oblong rectangular parallelepiped tip shape having a predetermined clearance angle and a predetermined rake angle by the upper punch, the lower punch, and the mortar die; and sintering the tip formed product.

2. The method for manufacturing the tip for the metal cutting circular saw according to claim 1, wherein the lower surface of the upper punch and the upper surface of the lower punch are formed into inclined surfaces corresponding to a clearance angle of the tip to be formed, thereby forming the tip-forming metal material into a tip shape having the predetermined clearance angle.

3. The method for manufacturing the tip for the metal cutting circular saw according to claim 2, wherein the inclined surface of the lower surface of the upper punch has an upper portion provided with a reverse inclined cutting edge forming surface portion corresponding to a cutting edge of the rake face of the tip to be formed, thereby forming the tip-forming metal material into a tip shape provided with the cutting edge having the predetermined rake angle.

4. The method for manufacturing the tip for the metal cutting circular saw according to claim 2, wherein the inclined surface of the upper surface of the lower punch has a lower portion provided with a protrusion having a substantially inverted V-shaped cross section.

5. The method for manufacturing the tip for the metal cutting circular saw according to claim 1, wherein the lower surface of the upper punch and the upper surface of the lower punch are formed into horizontal planes, and the horizontal plane of the lower surface of the upper punch has one side portion provided with a cutting edge forming surface portion of a predetermined inclination shape corresponding to a cutting edge of the rake face of the tip to be formed, and the cavity of the mortar die has one side inner surface provided with a flank-forming inclined surface portion inclined inward of the cavity from a lower end of the cutting edge forming surface portion of the upper punch toward the lower punch side, thereby forming the tip-forming metal material into a tip shape having the predetermined clearance angle and the predetermined rake angle.

6. The method for manufacturing the tip for the metal cutting circular saw according to claim 5, wherein the upper surface of the lower punch has the other side portion provided with a protrusion having a substantially inverted V-shaped cross section.

7. The method for manufacturing the tip for the metal cutting circular saw according to claim 1, wherein a plurality of the cavities are provided to the mortar die, and corresponding to the plurality of cavities, a plurality of the upper punches are provided to the upper die, and a plurality of the lower punches are provided to the lower die, and a plurality of the tip formed products are formed by a single operation of forming, and the tip formed products are put into a sintering furnace to simultaneously sinter a plurality of the tips.

8. A method for manufacturing a metal cutting circular saw, comprising: fixing the tip obtained by the method for manufacturing the tip according to claim 1 to each pedestal formed on an outer periphery of a base metal at a predetermined interval.

9. The method for manufacturing the metal cutting circular saw according to claim 8, wherein the tip is deburred before being fixed to each pedestal of the base metal.

10. The method for manufacturing the metal cutting circular saw according to claim 9, wherein a coating is applied to a surface of the tip before the deburred tip is fixed to each pedestal of the base metal.
